(19) United States
(12) Patent Application Publication
(10) Pub. No.: US 2024/0181951 A1
(43) Pub. Date: Jun. 6, 2024

(54) EXPANDABLE MOBILE HOUSE WITH LOFT

(71) Applicant: A&C FUTURE, INC., Newport Beach, CA (US)

(72) Inventors: Zhuangboyu Zhou, Santa Ana, CA (US); Ju Gao, Newport Beach, CA (US); Jiuqi Wang, Santa Ana, CA (US); Sichen Li, Santa Ana, CA (US); Xunmin Jiang, Irvine, CA (US); Shoue CHEN, Irvine, CA (US); Han Qin, Newport Beach, CA (US); Jiayang Qin, Newport Beach, CA (US)

(21) Appl. No.: 18/073,421

(22) Filed: Dec. 1, 2022

(51) Int. Cl. B60P 3/34

(52) U.S. Cl. CPC B60P 3/34

(57) ABSTRACT

An expandable home can expand horizontally with walls and floors that are foldable to the side of the structure. The movable house structure can be road mobile in a stowed state and can be expanded into a multi-bedroom house with a loft in an expanded state. The two outside walls can be driven out from the main body frame and two floor panels are hingedly connected with the body frame to be folded down for the expanded room. There are two retractable roofs on the top of the main structure that can be pulled out with the outside walls. The loft part can be raised from the main structure, where the floor panel for the loft is preset. Two long side wall panels are hingedly connected and folded into the middle while the two short wall panels are inserted into and raised from the short wall panels of first floor.

### BACKGROUND OF THE INVENTION

### 1. Field of the Invention

Embodiments of the invention relate generally to expandable homes. More particularly, embodiments of the invention relate to a mobile house that can be expanded upward to create a loft living space.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

An expandable moveable house structure is gaining in popularity in recent years. In most expandable house designs, there are few with a second floor. A mobile house or recreational vehicle are both developed to be expandable. Typically, such structures include one or more slide outs that can slide outward from the main structure to expand the living space. Often, expansion may occur on one side of the main structure, while some such mobile structures may expand on opposing sides.

In view of the foregoing, there is a need for an expandable house that can expand in multiple directions, including upward, to increase living space.

### SUMMARY OF THE INVENTION

Embodiments of the present invention aim to solve the aforementioned problems in conventional expandable homes. Embodiments of the present invention permit expansion of the house in three directions. Besides the regular horizontal expansion, some mechanisms are added to let the house expand upward to create a loft. The house can expand in horizontal direction with a 1:3 or 1:5 ratio and it can expand up for a room with the similar size of the main body room. This design creates an individual space on the second floor. It gives more flexibility of indoor design and people will enjoy a larger space with the same original area.

Embodiments of the present invention provide an expandable structure transformable between a stowed state and an expanded state comprising a main structure; a first expanded section, the first expanded section expandable outward in a first direction from a first side of the main structure; and a third expanded section, the third expanded section expandable upward to create a living space above an interior space of the main structure, wherein the third expanded section has a length approximately equal to a length of the main structure.

Embodiments of the present invention provide an expandable structure transformable between a stowed state and an expanded state comprising a main structure; a first expanded section, the first expanded section expandable outward in a first direction from a first side of the main structure; a second expanded section, the second expanded section expandable in a second direction, opposite the first direction, from a second side of the main structure; and a third expanded section, the third expanded section expandable upward to create a living space above an interior space of the main structure, wherein extension and retraction of the outer wall is performed without changing an interior space within the main structure.

Embodiments of the present invention provide an expandable structure transformable between a stowed state and an expanded state comprising a main structure; a first expanded section, the first expanded section expandable outward in a first direction from a first side of the main structure; a second expanded section, the second expanded section expandable in a second direction, opposite the first direction, from a second side of the main structure; and a third expanded section, the third expanded section expandable upward to create a living space above an interior space of the main structure, wherein the third expanded section has a length approximately equal to a length of the main structure; and extension and retraction of the outer wall is performed without changing an interior space within the main structure.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 illustrates a perspective view of an expandable home in a stowed state, according to an exemplary embodiment of the present invention;

FIG. 2A illustrates a perspective view of the expandable home of FIG. 1, in an expanded state;

FIG. 2B illustrates a front view of the expanded home of FIG. 2A;

FIG. 3 illustrates a frame member for a side wall of the expandable home of FIG. 1A and its extension from a main structure frame element;

FIG. 4 illustrates a cut-away side view showing floor deployment in one of the side extensions of the expandable home of FIG. 2A;

FIG. 5 illustrates how side walls pivot out to create walls on the side extensions of the expandable home of FIG. 2A;

FIG. 6 illustrates a partially expanded main structure, with the loft structure and expansion walls removed for clarity;

FIG. 7 illustrates the side extension expansion of the expandable home of FIG. 2A, showing roof expansion along with expansion of the side expansion outer wall;

FIG. 8 illustrates a perspective view of a portion of a loft structure of the expandable home of FIG. 2A, showing end walls that extend from the main structure;

FIG. 9 illustrates a cut away end view of the loft structure of the expandable home of FIG. 2A, showing folding long walls in a partially expanded state; and

FIG. 10 illustrates a perspective view of a roof structure of the loft structure of the expandable home of FIG. 2A.

The illustrations in the figures may not necessarily be drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

As is well known to those skilled in the art, many careful considerations and compromises typically must be made when designing for the optimal configuration of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide an expandable home that can be folded to a size that is mobile and can expand horizontally with flexible walls and floors. The walls and floors are foldable to the side of the structure. The movable house structure can be applied to an innovative RV which has a regular vehicle size in its stowed state, and it can be expanded to a multi-bedroom house with a loft in an expanded state. There are mechanisms to drive the two outside walls out from the main body frame and two floor panels are hingedly connected with the body frame. The floor panels can be folded down for the expanded room. There are two retractable roofs on the top of the container that can be pulled out with the outside walls. The loft part can include four foldable wall panels and a top roof. The floor panel for the loft is preset and does not need to be folded. Two long side wall panels are hingedly connected and folded into the middle while the two short wall panels are inserted into and raised from the short wall panels of first floor.

The figures are briefly described below, followed by a broader discussion of each figure and the components therein.

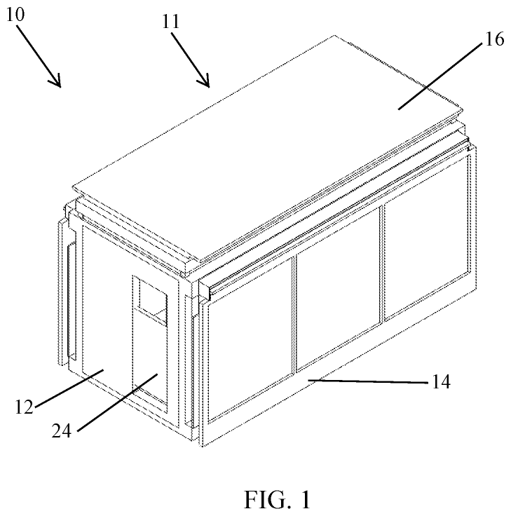

FIG. 1 shows the folded/stowed state of the expandable house with a loft. The example shown is 8 feet, 6 inches in width and 20 feet in length. Since the structure can be applied to a recreational vehicle, a size under the road limit is used as an example. As shown in the figure, two outside walls for deployed/expanded state are attached to the main frame with telescoping side frame members as described in greater detail below.

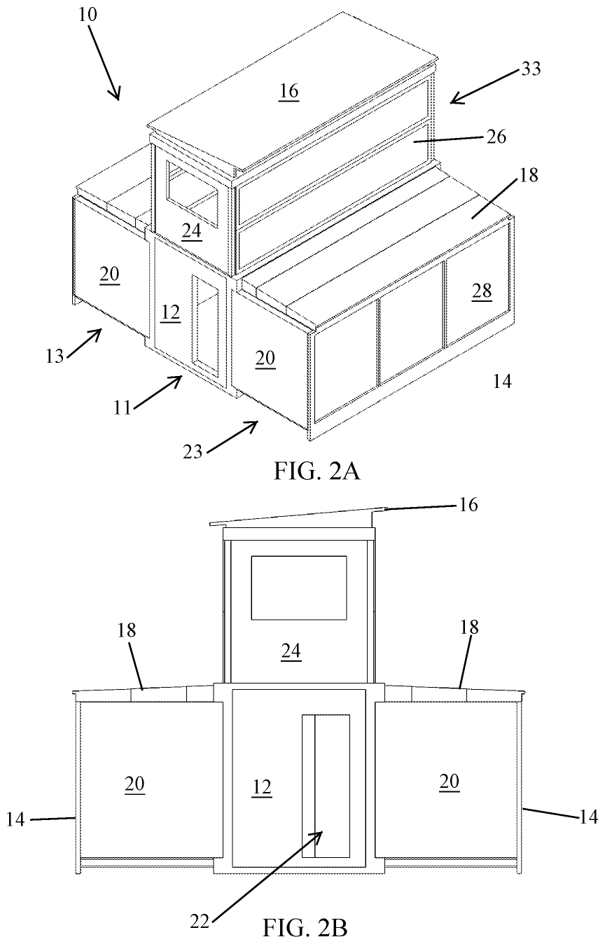

FIG. 2A illustrates the isometric view of the expanded state of the expandable house. There are three cabins on the first floor, one based on the main structure, and two expanded sections, and one cabin on the second floor, based on the expanded loft structure. The entire structure is covered with an inclined roof. As shown in FIG. 2B, each roof has an inclined angle from 2 to 4 degrees, for example. This will help maintain a waterproof state for the structure.

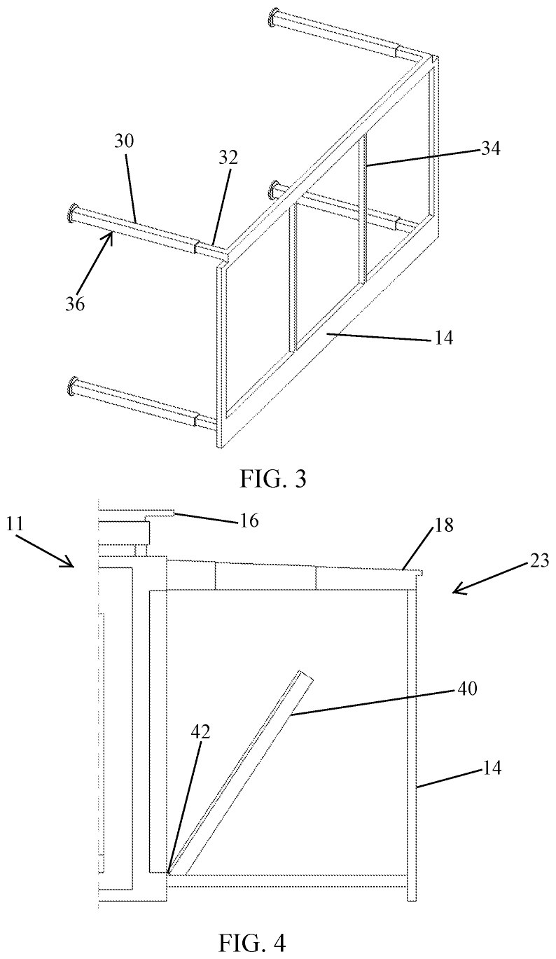

FIG. 3 illustrates how the expandable wall panel is connected with the main body frame. Four hydraulic rods can be disposed at the corners. The hollow rods can be fixed in the main body frame. The hydraulic rods can control outward and inward movement of the two outside walls. Of course, other expansion mechanisms may be used, such as pneumatic, motorized with gears, or even manual movement.

After the outside wall has been driven out, the side floor, which is hingedly connected with the body frame, can be folded down. This floor panel can be connected by a linkage set and some power motors, for example. As shown in FIG. 4, the floor panel has a limit defined by the height of the main body. The floor panel can be fixed at the bottom of the outside wall after it has been fully expanded down.

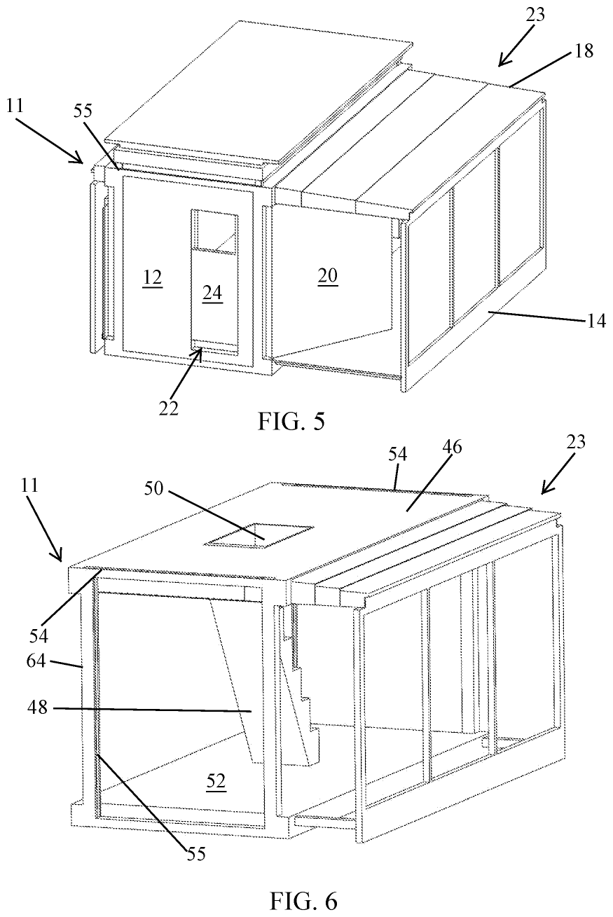

FIG. 5 illustrates how the side walls pivot out after the floor panels are expanded down. The walls are rotatable respectively to the axis on the main body frame. These side wall panels will cover the sides of the expanded space.

FIG. 6 illustrates the first-floor frame structure. As shown in FIG. 6, two short sides walls of the main body frame are hollow. Two screw rods can be set in the column. The short walls for the second floor can be inserted in the hollow first floor side walls. The short walls can be connected with ball screw rods, for example. When the screw rods are driven by a motor and spinning, they will lift up the short walls and form the loft structure as a second floor.

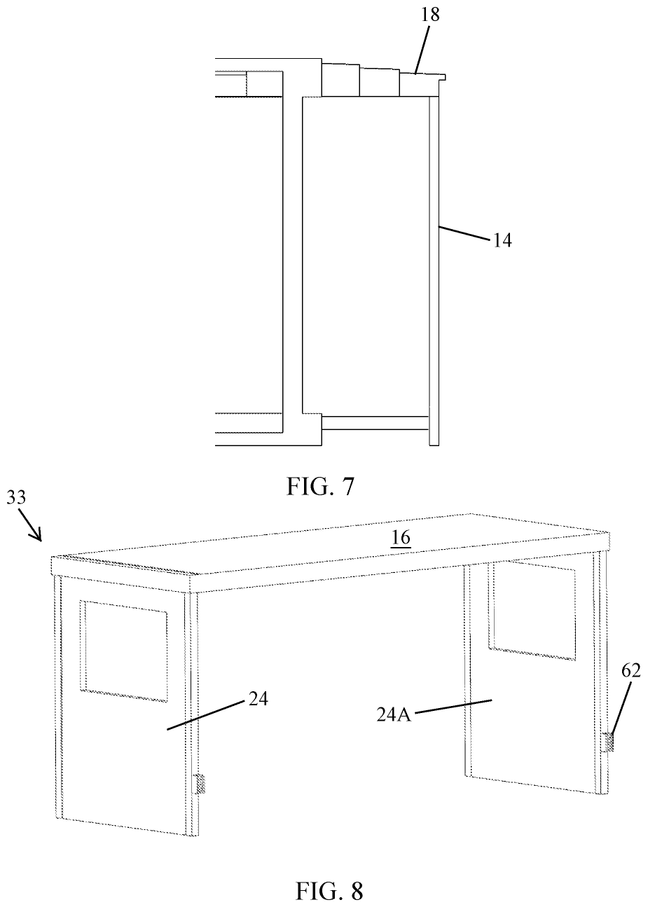

FIG. 7 illustrates the roof of first floor. Since the two expanded cabins have no second-floor structure over it, two retractable roofs can be used to cover the expanded cabins. The roof can be set inside the roof slab of the main structure and can be attached to and pulled in and out with movement of the outside walls.

FIG. 8 illustrates the components of the second-floor frame which can include four columns which can be set with ball screw mechanisms with the ball screw rods in the main structure. There are two short walls between the short distance of the columns. These two wall panels are inserted into the hollow short walls for first floor.

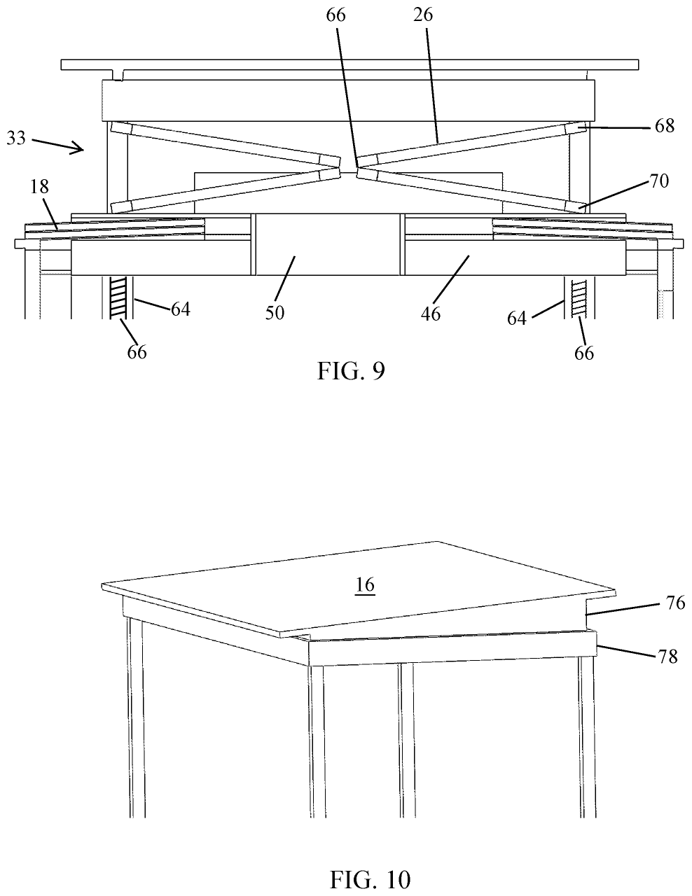

FIG. 9 illustrates the long side walls of the second floor. Each long side wall panel can be made of two panels. The two panels can be hingedly connected. They are also both hingedly connected with the slab of the main structure and the roof. FIG. 9 is a sectional view of the second floor of the expandable house structure where the two long side walls of the second floor are folded in the middle.

FIG. 10 illustrates the rotatable roof design for the second floor. The roof can be pushed into the slab of the main structure in the stowed state. The roof can rotate along the axis along one edge of the ceiling to form a sloped roof in the expanded state.

Referring now to FIGS. 1 through 2B, an expandable house 10 (also referred to as house 10) can include a front wall 12 with a front door 22 formed therein, an expandable side wall 14, a rear wall (not shown) and a roof 16. While the figures describe expansion of the side wall 14 on opposite sides of the house 10, one or both sides may be expandable. The description below will focus on one side of the house 10, but it should be understood that the mechanisms on the other side of the house 10, when present, are similar.

The house 10 may include a main structure 11. In the stowed state, the footprint of the house 10 is generally defined by the main structure 11. In the expanded state, one or more side portions may expand from sides of the main structure 11. For example, as shown in FIGS. 2A and 2B, a first expanded section 13 may expand from one side of the main structure 11 and a second expanded section 23 may expand from the other side of the main structure 11. A third expanded section 33 may expand upward from the main structure 11 to form a loft area. Typically, the first and second expanded sections 13, 23 may be along an entire length of the main section 11, as illustrated, but such expanded sections 13, 23 may be shorter than the main section 11, if desired. Similarly, the third expanded section 33 may be along an entire length of the main section 11, as illustrated, but may be shorter than the main section 11, if desired. In other words, the length of the third expanded section 33 may be approximately equal to the length of the main section 11, where an approximation is provided to allow for any reduction in overall length due to the fact that the front and rear walls of the third expanded section 33 are disposed within the front and rear walls of the main structure.

The first and second expanded sections 13, 23 may be covered by a retractable roof 18, while the third expanded section 33 may be covered by the roof 16 that is also the roof for the main structure 11 when in the stowed state as shown in FIG. 1. The first and second expanded sections 13, 23 may include an outer wall 14 and side walls 20. The third expanded section 33 may include folding long walls 26 and end walls 24. Details of the deployment of the walls is discussed in greater detail below.

Referring to FIG. 3, the outer wall 14 of the first and second expanded sections 13, 23 is shown. Hollow tubes 30 may be disposed and fixed in the main structure 11, while arms 32 may telescope in and out of the hollow tubes 30 to transform between the stowed and expanded states. Various movement means 36 may be disposed in the hollow tubes 30, such as hydraulic members, pneumatic members, linear actuators, gears and motors, or the like. The outer wall 14 can include side wall panels 28 (see FIG. 2A) that are removed in FIG. 3 for clarity. The side wall panels 28 can be disposed between outer wall studs 34 for support. The front and back ends of the outer wall 14 may be open and filled by pivoting side walls, as discussed below.

Referring to FIG. 4, within the first and second expanded sections 13, 23, a floor member 40 may be folded alongside the main structure 11 and, once the outer wall 14 is expanded, the floor member 40 may pivot about an axis 42 to form a floor surface in the expanded section 13, 23. The floor member 40 may be driven between the stowed and expanded states or may be manually moved by the user. In some embodiments, a distal end of the floor member 40 may be pivotably attached to the outer wall 14 and may slide vertically along the same. In this embodiment, the floor member 40 may be automatically deployed during expansion of the outer wall 14.

Referring now to FIGS. 5 and 7, the roof 18 may be formed of a plurality of roof panels that store into the upper slab 46 (see FIG. 6) of the main structure 11. The outermost one of the roof panels may be attached to the outer wall 14 so that expansion of the outer wall 14 pulls out the roof 18 automatically. Side walls 20 may be folded against the main structure 11 in the stowed state and may pivot outward, as shown in FIG. 5, to cover the opening in the second extended section 23. As can be seen in FIG. 5, when the loft is not extended, the front wall 24 of the loft may be seen in the doorway 22 of the main structure 11.

Referring to FIG. 6, a cut-away view of the main structure 11, with the second extended section 23 partially extended is shown. Stairs 48 may be provided to extend from a floor surface 52 to opening 50 at a top end thereof. The opening 50 provides access to the loft when the third expanded section (see FIG. 2A) is in the expanded state. The slab 46 may provide the floor surface for the third expanded section. Slots 54 may be provided at front and rear ends of the slab 46 so that the front wall 24 and the rear wall 24A (see FIGS. 5 and 8, for example) may be disposed into the slots 54 when in the stowed state. Pillars 64 of the main structure 11 may house a mechanism for lifting and retracting the side walls 24, 24A and the roof 16 upward from the main structure 11. The mechanism may include, for example, a screw 66, or similar structure (see FIG. 9), that may engage with an engagement feature 62, such as a gear or similar structure (see FIG. 8) on the sides of the front and rear walls 24, 24A. Of course, various mechanisms as may be known in the art, may be used to affect movement of the side walls upward and downward through the slots 54.

FIG. 8 shows the third expanded section 33, without the side walls. Front and rear side walls 24, 24A may extend downward from the roof 18, where the side walls 24, 24A may include an engagement feature 62, as discussed above, to help facilitate raising and lowering the third expanded section 33. In some embodiments, the front and rear side walls 24, 24A may extend through the slots 54 and into a hollow space 55 (see FIGS. 5 and 6) within the front wall 12 and the rear wall.

Referring now to FIGS. 9 and 10, the third expanded section 33 is shown with the side walls 26 partially extended. The side walls 26 may be formed from two wall panels connected to each other at a pivot axis 66. A top end of the side wall 26 can attach adjacent the roof 16 at an upper pivot axis 68, while the bottom end of the side wall 26 can attach adjacent the upper surface of the slab 46 at a lower pivot axis 70. Thus, as the side walls raise out of the slots 54, as described above, the side walls 26 may unfold to form flat slide walls enclosing the interior of the third expanded section 33. Once expanded, the roof 16 may be angled from a roof frame 78 by raising one side 76 of the roof 16. In some embodiments, the roof 16 may be angled regardless of whether the house 10 is in the stowed or expanded state. In other embodiments, the roof 16 may angle only when the house 10 is in the expanded state and may remain relatively flat when in the stowed state, thus reducing wind resistance when the house is movable, such as being part of a recreational vehicle.

While not shown, it should be understood that various support structures may be included, depending on the specific application. For example, if the main structure 11 is disposed on a chassis, the first and second expanded sections 13, 23 may include legs that may support outer ends thereof.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. An expandable structure transformable between a stowed state and an expanded state, the expandable structure comprising:
a main structure;
a first expanded section, the first expanded section expandable outward in a first direction from a first side of the main structure; and
a third expanded section, the third expanded section expandable upward to create a living space above an interior space of the main structure, wherein
the third expanded section has a length approximately equal to a length of the main structure.

2. The expandable structure of claim 1, further comprising a second expanded section, the second expanded section expandable in a second direction, opposite the first direction, from a second side of the main structure.

3. The expandable structure of claim 1, wherein the first expanded section includes horizontal arms that telescope from fixed arms in the main structure.

4. The expandable structure of claim 1, wherein front and rear walls of the first expanded section fold against the main structure in the stowed state and pivot from the main structure to form front and rear walls of the first expanded section when in the expanded state.

5. The expandable structure of claim 1, wherein a floor member folds against the main structure in the stowed state and pivots from the main structure to form a floor surface for the first expanded section when in the expanded state.

6. The expandable structure of claim 1, further comprising:
an at least partially hollow slab forming an upper portion of the main structure; and
a retractable roof having a plurality of roof panels covering the first expanded section when in the expanded state, wherein
the retractable roof is at least partially disposed inside the at least partially hollow slab when in the stowed state;
an outermost one of the plurality of roof panels is attached to an outer wall of the first expanded section; and
extension and retraction of the outer wall causes extension and retraction of the roof.

7. The expandable structure of claim 1, wherein extension and retraction of the outer wall is performed without changing an interior space within the main structure.

8. The expandable structure of claim 1, further comprising:
an at least partially hollow slab forming an upper portion of the main structure; and
slots formed along a front edge and a rear edge of the slab, the slots extending through the slab, from a top end to a bottom end of the slab, wherein:
a front wall and a rear wall of the third expanded section moves within the slots during expansion and retraction of the third expanded section.

9. The expandable structure of claim 8, wherein the front wall and the rear wall of the third expanded section extends through the slots and into a hollow space formed in front and rear walls of the main structure when in the stowed state.

10. The expandable structure of claim 8, wherein:
side walls of the third expanded section are each formed from first and second side panels;
an upper end of the first side panel is pivotably connected along a side edge of a roof section of the third expanded section;
a lower end of the second side panel is pivotably connected along a side edge of an upper surface of the slab;
a lower end of the first side panel is pivotably connected to an upper end of the second side panel;
in the stowed state, the first and second side panels fold inward where outer faces of each of the first and second side panels face each other; and
in the deployed state, the first and second side panels unfold to form the side wall of the third expanded section.

11. The expandable structure of claim 8, wherein an expanded section roof of the third expanded section is movable into an angled roof.

12. The expandable structure of claim 11, wherein the expanded section roof is angled from about 2 degrees to about 4 degrees.

13. The expandable structure of claim 1, further comprising stairs within an interior space of the main structure, the stairs extending from a floor surface of the main structure to an opening in a ceiling of the main structure.

14. The expandable structure of claim 8, wherein extension and retraction of the outer wall is performed without changing an interior space within the main structure.

15. An expandable structure transformable between a stowed state and an expanded state, the expandable structure comprising:
a main structure;
a first expanded section, the first expanded section expandable outward in a first direction from a first side of the main structure;
a second expanded section, the second expanded section expandable in a second direction, opposite the first direction, from a second side of the main structure; and
a third expanded section, the third expanded section expandable upward to create a living space above an interior space of the main structure, wherein
extension and retraction of the outer wall is performed without changing an interior space within the main structure.

16. The expandable structure of claim 15, wherein:
front and rear walls of the first expanded section fold against the main structure in the stowed state and pivot from the main structure to form front and rear walls of the first expanded section when in the expanded state; and
a floor member folds against the main structure in the stowed state and pivots from the main structure to form a floor surface for the first expanded section when in the expanded state.

17. The expandable structure of claim 15, further comprising:
an at least partially hollow slab forming an upper portion of the main structure; and
slots formed along a front edge and a rear edge of the slab, the slots extending through the slab, from a top end to a bottom end of the slab, wherein:
a front wall and a rear wall of the third expanded section extend through the slots and into a hollow space formed in front and rear walls of the main structure when in the stowed state;
side walls of the third expanded section are each formed from first and second side panels;
an upper end of the first side panel is pivotably connected along a side edge of a roof section of the third expanded section;
a lower end of the second side panel is pivotably connected along a side edge of an upper surface of the slab;
a lower end of the first side panel is pivotably connected to an upper end of the second side panel;
in the stowed state, the first and second side panels fold inward where outer faces of each of the first and second side panels face each other; and
in the deployed state, the first and second side panels unfold to form the side wall of the third expanded section.

18. An expandable structure transformable between a stowed state and an expanded state, the expandable structure comprising:
a main structure;
a first expanded section, the first expanded section expandable outward in a first direction from a first side of the main structure;
a second expanded section, the second expanded section expandable in a second direction, opposite the first direction, from a second side of the main structure; and
a third expanded section, the third expanded section expandable upward to create a living space above an interior space of the main structure, wherein the third expanded section has a length approximately equal to a length of the main structure; and
extension and retraction of the outer wall is performed without changing an interior space within the main structure.

19. The expandable structure of claim 18, further comprising:
a slab forming an upper portion of the main structure; and
slots formed along a front edge and a rear edge of the slab, the slots extending through the slab, from a top end to a bottom end of the slab, wherein:
a front wall and a rear wall of the third expanded section extend through respective slots and into a hollow space formed in front and rear walls of the main structure when in the stowed state;
side walls of the third expanded section are each formed from first and second side panels;
an upper end of the first side panel is pivotably connected along a side edge of a roof section of the third expanded section;
a lower end of the second side panel is pivotably connected along a side edge of an upper surface of the slab;
a lower end of the first side panel is pivotably connected to an upper end of the second side panel;
in the stowed state, the first and second side panels fold inward where outer faces of each of the first and second side panels face each other; and
in the deployed state, the first and second side panels unfold to form the side wall of the third expanded section.

20. The expandable structure of claim 18, wherein:
front and rear walls of the first expanded section fold against the main structure in the stowed state and pivot from the main structure to form front and rear walls of the first expanded section when in the expanded state; and
a floor member folds against the main structure in the stowed state and pivots from the main structure to form a floor surface for the first expanded section when in the expanded state.
